(19) United States
(12) Patent Application Publication
(10) Pub. No.: US 2013/0173039 A1
(43) Pub. Date: Jul. 4, 2013

(54) METHODS AND DEVICES FOR DETERMINING A TEACHING POINT LOCATION USING PRESSURE MEASUREMENTS

(71) Applicants: Bradley Edwin Rowell, Plymouth, MN (US); Shawn Allen Ruden, Shakopee, MN (US)

(72) Inventors: Bradley Edwin Rowell, Plymouth, MN (US); Shawn Allen Ruden, Shakopee, MN (US)

(73) Assignee: Seagate Technology LLC, Shakopee, MN (US)

(21) Appl. No.: 13/343,064

(22) Filed: Jan. 4, 2012

(51) Int. Cl. B25J 9/10; G06F 15/18; G01L 21/00; B25J 15/06

(52) U.S. Cl. 700/97; 702/138; 702/140; 901/40; 901/3

(57) ABSTRACT

Certain embodiments of the present invention are generally directed to devices and methods for using pressure measurements to teach a robot a teaching point location.

In certain embodiments, a method includes measuring pressure at multiple points across a target. A location of a robot teaching point is determined based on the measured pressure.

### SUMMARY

Certain embodiments of the present invention are generally directed to devices and methods for using pressure measurements to teach a robot a teaching point location.

In certain embodiments, a method includes measuring pressure at multiple points across a target. A location of a robot teaching point is determined based on the measured pressure.

### BRIEF DESCRIPTION OF THE DRAWINGS

FIG. 1 provides a block diagram of an exemplary system, in accordance with certain embodiments of the present disclosure. FIGS. 2A-D provide a view of an exemplary system at multiple stages of performing a method in accordance with certain embodiments of the present disclosure.

FIG. 3 provides an exemplary graph, in accordance with certain embodiments of the present disclosure.

FIG. 4 provides a routine illustrative of steps carried out in accordance with certain embodiments of the present disclosure.

### DETAILED DESCRIPTION

The present disclosure relates to devices, systems, and methods for using pressure measurements to teach a robot a teaching point location. In the field of automated assembly, robots can be used for tasks such as picking and placing components onto an assembly, creating welds, installing hardware, etc. For example, a robot may utilize a robot arm with an end-effector to pick, transport, and/or place components. To perform such tasks automatically, the robot needs to be taught the location(s) of the picking and placing. Once taught, the robot can utilize end effectors such as those with vacuum ports to pick, hold, and release components during assembly and manufacturing processes.

Previous attempts for determining target point locations included using pin gages and human subjectivity. More automated teaching point methods can require additional equipment like cameras, contact sensors, and machine vision devices—all of which add cost and complexity to the teaching point process. Certain embodiments of the present disclosure are accordingly directed to systems, devices, and methods for using pressure measurements to teach a robot a target location.

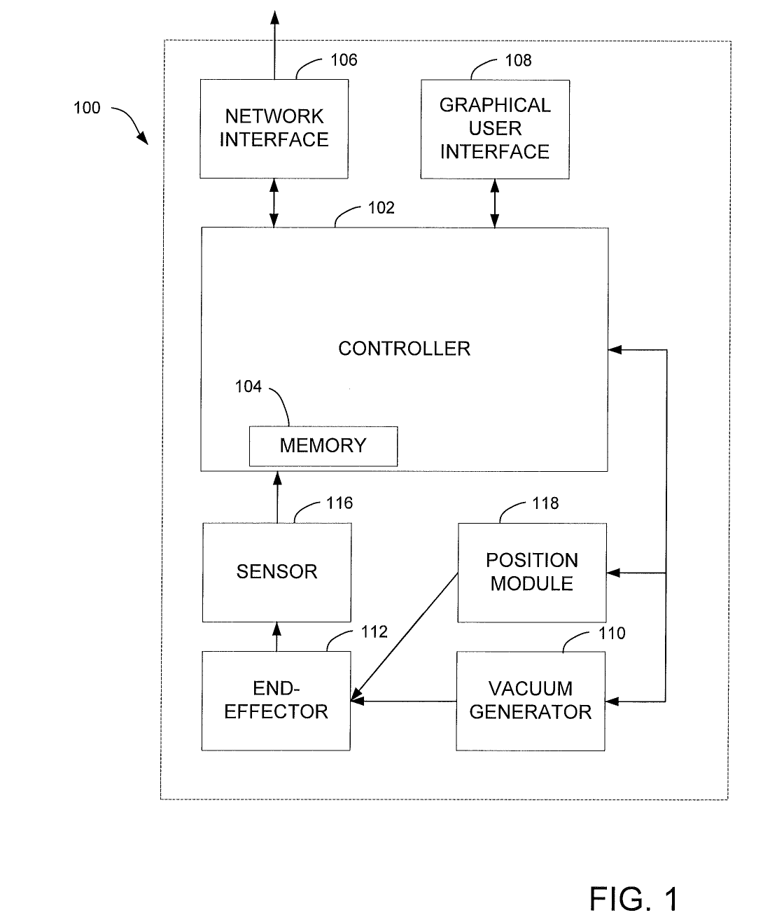

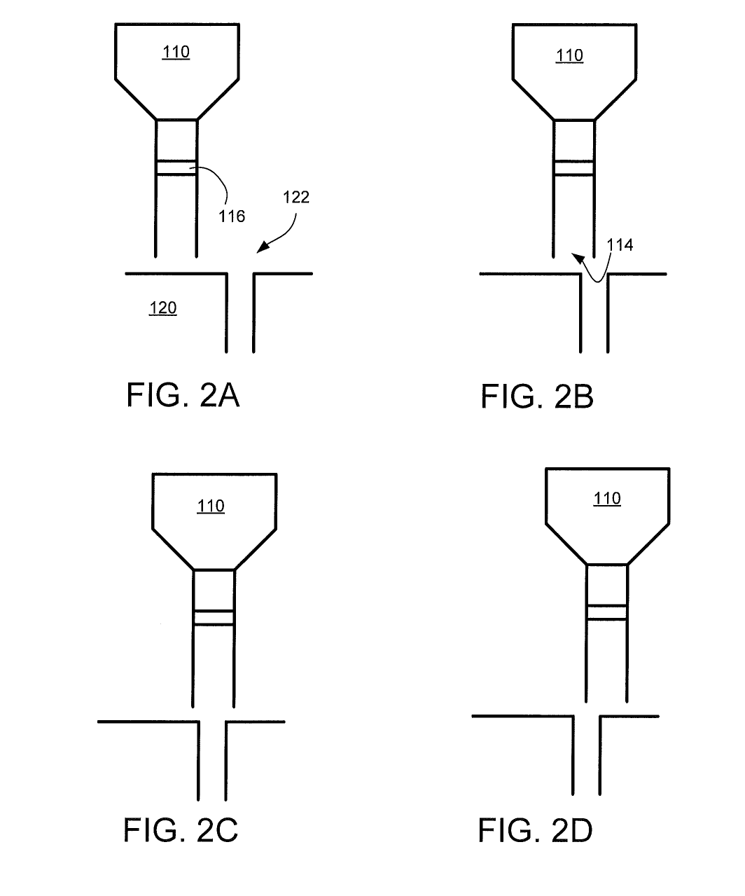

FIG. 1 provides a functional block diagram of a system 100, some parts of which are shown in FIGS. 2A-D. The system 100 includes a controller 102 having a controller memory 104, network interface 106, graphical user interface (GUI) 108, vacuum generator 110, end-effector 112 with a port 114, sensor 116, and position module 118. The controller 102 controls the system 100 using programming and data stored in controller memory 104. The network interface 106 facilitates communication of the controller 102 with a computer network. The GUI 108 allows user input and displays data and results via a computer keyboard and monitor, for example. The system 100 can be implemented in a robotic system to determine robot teaching points.

As shown in FIGS. 2A-D, the vacuum generator 110 generates a vacuum and is in fluid communication with the end-effector 112 to provide pressure or a vacuum pressure at the end-effector port or opening 114. The end-effector 112 can be connected to a robotic arm and, for example, can function as a vacuum gripper or a screwdriver, among mechanisms comprising an end-effector. The sensor 116 is adapted to measure a pressure or vacuum pressure level within the system 100 and outputs its measurements to the controller 102. The position module 118 functions to move and position the end-effector 112 to different locations. For example, positioning systems can include a closed loop servo system that includes optical encoder feedback, among other positioning devices and methods. As shown in FIG. 2A, in use, the end-effector 112 is positioned close to a workpiece 120 near a target feature 122, which is shown as a void (e.g., hole, slot, or cavity) but can be a solid object like a boss or protrusion. The end-effector 112 is moved over or across the target feature 122 while the vacuum level is measured and recorded at multiple points (e.g., FIGS. 2A-D). Alternatively, pressure can be measured at multiple points in an area of interest, where the area of interest includes the target feature 122.

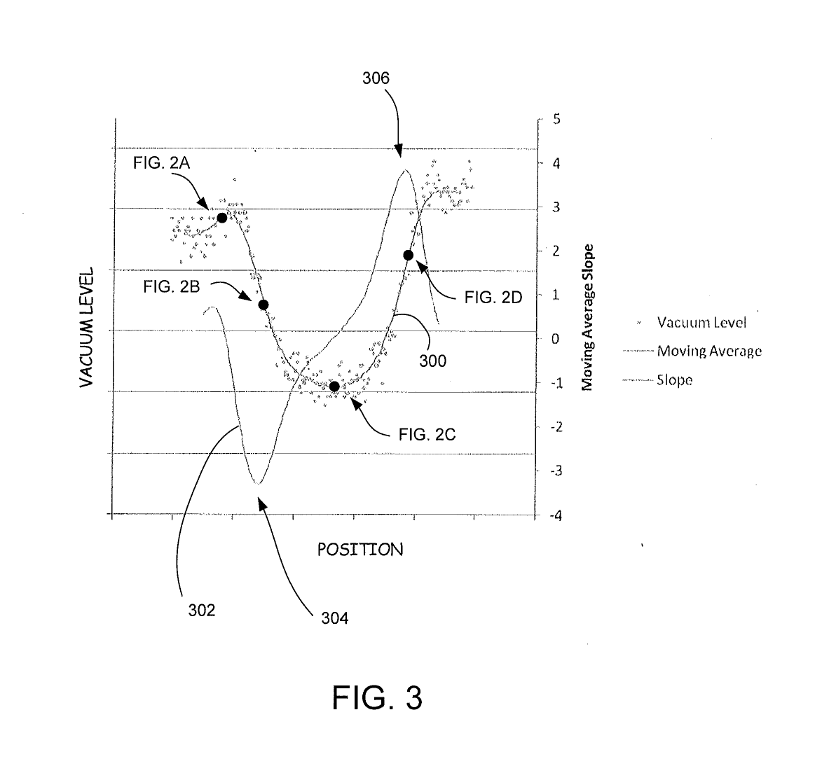

As a result of the pressure measurements, a vacuum level profile 300 can be obtained, which is shown in FIG. 3. If the target feature 122 is a void, the vacuum level profile 300 shows a lower vacuum pressure in the area of the void 122 and a higher vacuum pressure at a surface of the workpiece 120. This type of profile is shown in FIG. 3, which features different points along the profile 300 that relate to the different positions of the end-effector in FIGS. 2A-D. An opposite relationship will exist for a solid target feature. Once the profile is obtained, the vacuum level profile can be analyzed to determine a location of a robot teaching point—a point at which a robot may pick or place a component. For example, the teaching point may be an interpolated centerpoint for a pick or place location.

When analyzing the measured vacuum levels, one possible analysis includes calculating a moving average of the vacuum level data and then calculating a slope of the moving average. FIG. 3 includes a plot of a moving average slope 302. The location of the teaching point is a midpoint between positions of minimum 304 and maximum 306 of the moving average slope 302. Other statistical methods can be used to analyze the measure vacuum levels, and this process is not limited to or bound by the use of the aforementioned statistical method.

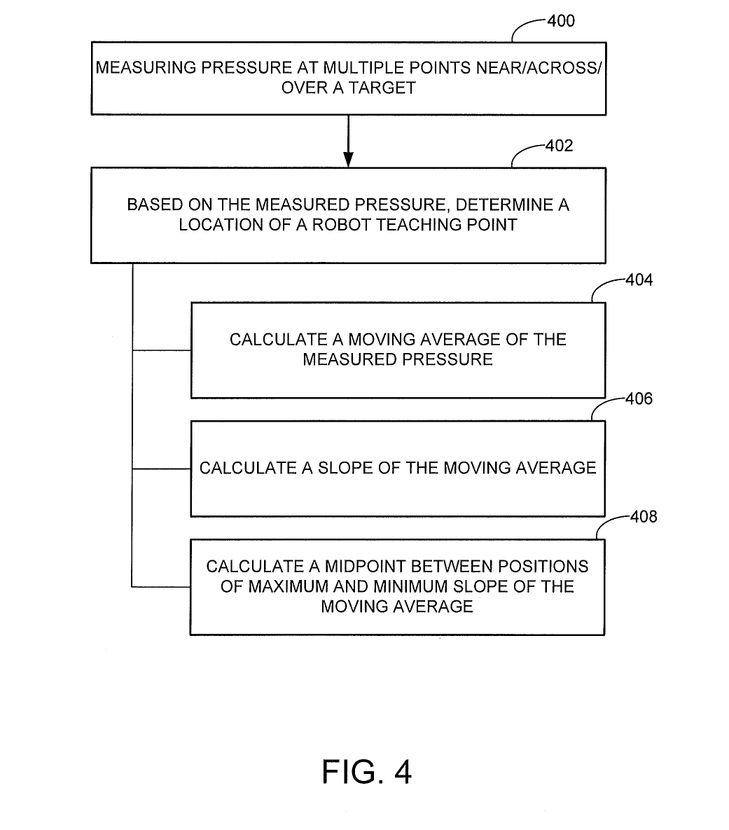

FIG. 4 provides a routine illustrative of steps carried out in accordance with certain embodiments of the present disclosure. As described above, the steps include measuring pressure at multiple points across a target (step 400). Based on the measured pressure, a location of a robot teaching point can be determined (step 402). More specifically, the step 402 can include calculating a moving average of the measure pressure (step 404), calculating a slope of the moving average (step 406), and determining the location of the robot teaching point by calculating a midpoint between positions of maximum and minimum slope of the moving average (step 408). Steps 400 and 402 can be performed for one axis or direction (e.g., x-axis) and then repeated for another axis (e.g., y-axis). The measuring and analyzing can be performed without contact between parts, thereby mitigating contamination and particle creation. However, the method is not limited to being contactless. Once the teaching point is determined, that point can be used during automated assembly, among other processes, to know where to pick and place components using a robot and/or end-effector.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. A method comprising:
providing a target feature;
measuring pressure at multiple points spanning an area of interest that includes a target feature;
creating a pressure profile based on the measured pressure; and
based on the measured pressure, determining a location of a robot teaching point for use during automated assembly.

2. The method of claim 1, wherein the measured pressure is a vacuum pressure.

3. The method of claim 1, wherein the target is a void in a surface

4. The method of claim 1, wherein the target is a boss protruding from a surface.

5. The method of claim 1, further comprising:
picking and/or placing a component at the robot teaching point location.

6. A system comprising:
a vacuum generator;
an end-effector having a vacuum port in fluid communication with the vacuum generator;
a sensor that measures a vacuum level within the system at multiple points near a target; and
a controller that determines a location of a robot teaching point based on the measured vacuum levels.

7. The system of claim 6, wherein the end-effector is a vacuum gripper.

8. The system of claim 6, wherein the end-effector is a screwdriver with an opening in fluid communication with the vacuum generator.

9. The system of claim 6, further comprising a controller memory that stores the measured vacuum levels.

10. The system of claim 9, wherein the controller generates a vacuum level profile of the measured vacuum levels.

11. A method comprising:
measuring pressure at multiple points across a target; and
determining a location of a robot teaching point based on the measured pressure.

12. The method of claim 11, wherein the measured pressure is a vacuum pressure.

13. The method of claim 12, further comprising:
generating a profile of the measured pressure.

14. The method of claim 13, further comprising:
calculating a moving average of the measured pressure;
calculating a slope of the moving average; and
determining the robot teaching point by calculating a midpoint between positions of maximum and minimum slope of the moving average.

15. The method of claim 11, wherein the measuring step and the determining step is used for determining the target position in a first direction, and repeating the measuring step and the determining step for determining the target position in a second direction.

16. The method of claim 11, wherein the robot teaching point represents a pick or place location.

17. The method of claim 13, wherein the target is a void in a surface.

18. The method of claim 17, wherein the generated profile comprises lower vacuum pressure measurements over the void and higher vacuum pressure measurements over the surface.

19. The method of claim 11, wherein the target is a boss protruding from a surface.

20. The method of claim 11, wherein the method is performed without contacting a workpiece surface.
